(19) United States
(12) Patent Application Publication
(10) Pub. No.: US 2004/0037361 A1
(43) Pub. Date: Feb. 26, 2004

(54) Video block error sensing by detection of shapes in output

(76) Inventor: Eduardo Gudis, Audubon, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/226,656

(22) Filed: Aug. 22, 2002

(51) Int. Cl. H04N 7/12

(52) U.S. Cl. 375/240.27; 375/240.24; 375/240.01; 375/240.12

(57) ABSTRACT

Errors are detected in a decoded video signal that has been processed at least partly in data blocks, such as MPEG-2 compression macroblocks or other block processed data, by discerning the appearance of a pattern of contrast in the decoded output video signal around the perimeter of an area corresponding to a processed block of pixels. In a compression technique, an error affecting one more members of a block of pixels generally affects the entire block. In the absence of an error, processed blocks most typically merge imperceptibly into one another with pixel values may that change little, if at all, across the border between abutting blocks. The error alters this situation and makes at least one of the blocks perceptible among the abutting blocks due to distinct contrast between the blocks. Image processing techniques are employed to discern an apparent block and thereby to discriminate for errors. The errors can be handled as appropriate, such as by generating an alarm, triggering a substitution of signal sources, repeating a stored block or the like.

### BACKGROUND OF THE INVENTION

1. Field of the Invention

The invention concerns detection of errors that occur when data is handled in blocks (encoded, transmitted, decoded, etc.) in a process wherein an error in one or more values tends to affect the whole associated block of values resulting from such process. Examples include compressed data such as video data, compressed image data and the like. The invention detects errors by discriminating for contrast that distinguishes the associated block from other blocks. Such contrast arises when a block is affected by an error in one or more of its associated data values.

2. Prior Art

Data compression arrangements advantageously involve certain processes wherein groups of individual data samples are handled together as a group. In connection with image data or digitized video, for example, the data samples may represent characteristics of discrete picture elements (also known as pixels or pels) that are arrayed to make up an image. Data values such as pixel data values may be associated in various groups for various purposes, such as packets for transmission, or frames or fields for display, etc. Some processes, and/or some sections of processes, handle grouped data values as independent entities. The value of a given data sample or similar data value has no effect on other values. In other processes, the members of a set of grouped data values can affect one another due to the manner in which they are handled.

Data compression techniques, for example, typically exploit data redundancy to reduce the number of bits needed to encode a signal for transmission or storage or the like. Such compression techniques can involve the handling of data values in groups or blocks of values. Spatially-adjacent pixels in an image frequently have equal or near equal values, due in part to the fact that distinct figures shown in the picture are typically larger than individual pixels. In a motion picture image, values for a pixel at a given spatial pixel position in a frame may persist for a time, with equal or near equal values from one scanned frame or field to the next over a succession of scans. In those situations, the equality or near equality of data values is a form of redundancy.

It is possible to compress the number of bits needed to digitally encode a signal that is redundant in one or more ways. In video processing, redundancies are often localized to an area of the picture, for the reasons described above. Thus, some effective video compression techniques are made possible by grouping together spatially and/or temporally adjacent data samples to define groups or blocks of nearby samples that are handled together as a group or data block. The data blocks can correspond to discrete areas of the picture. Depending on content, for example, fewer bits may be needed to represent a signal at a given level of precision, by encoding the sample values as the differences from some local average or other common value, than otherwise would be needed fully to encode each value independently.

It would be possible to have a video compression arrangement in which such blocks are successive pixels on individual horizontal scan lines. There is a comparable data compression advantage available by exploiting vertical data redundancy and defining the blocks to include adjacent pixels on successive vertically spaced horizontal lines in an area.

An exemplary compression technique may therefore involve encoding, transmitting or storing, decoding and similarly handling information about the whole of a processed block of pixels or samples in an X-Y array, as well as information defining how the values of individual pixels vary among the members of the group. As a simple example, the common information about the block could be an average value of a luma and/or chroma value for all the samples in the block. That average could be encoded together with information as to how each sample relates to the average. Additional compression techniques such as variable bit-length encoding schemes can be employed to use shorter bit lengths for the most frequently occurring values. Certain attributes of data compression techniques as described are also characteristic of other processes in which data is treated in blocks in a manner wherein the values of individual members of the block can affect other members at one or another point in their processing. These techniques are not limited data compression or to image and video data compression in particular. However image and video compression are representative, and accordingly are used as non-limiting examples in this disclosure.

This compression benefit applies to adjacent pixels and areas of the picture that are local and advantageously are treated in local areas or blocks of adjacent pixels. In this sense, “adjacent” is not limited to immediately abutting pixels, but generally concerns an array. Each array treated as a block may be of the same size and the blocks may occupy known positions in a regular array of pixels that form a standard sized image or frame. However, local pixel values handled in blocks or groups could optionally be larger or smaller, variable in size or fixed, variable in relative placement or fixed, etc. The decoding technique used to extract the data must be the inverse of the same technique that was used to encode the data. Preferably, the compression and decompression techniques, including at least the array size of the processed data blocks, are standardized.

When compressing data in this way, the values of every sample in a block affect the compressed values that characterize the block as a whole, as well as affecting the compressed values that characterize the respective sample individually. When decompressing or decoding compressed data, there is a similar effect that the values that characterize the block and its members are interdependent. An error associated with encoding, transmitting, processing and/or decoding a block, typically affects all the samples in the block.

MPEG-2 is an exemplary video compression standard that takes advantage of the spatial and temporal redundancies in a moving picture image. Temporal compression exploits redundancies between picture frames. Spatial compression exploits redundancy within a given frame. Particularly in connection with spatial blocks, the pixels in a local area are handled as a standard sized array of associated pixels in a unit called a “macroblock.” The same sort of block data handling is also applicable to compressed data representing still images and to other types of data.

Spatial compression in MPEG-2 comprises applying a two-dimensional discrete cosine transform (“DCT”), quantizing the coefficients, and coding them. The DCT is applied, for example, to a pixel block that is typically 16 by 16 pixels. Each pixel has associated luma and chroma values, but luma is typically sampled at a higher rate than chroma. MPEG-2 profiles typically use 4:2:0 sampling, meaning that color is downsampled by a factor of four. The 4:2:0 pixel image is split into macroblocks of 16×16 pixels.

Each macroblock has four 8×8 “Y” blocks (luma), one 8×8 Cb block and one 8×8 Cr block (Cb and Cr being color difference values). The DCT is applied to each block for Y, Cb and Cr, and combined to form one compression vector. One macroblock is a collection of values defining a square of 16×16 adjacent pixels in luma and chroma, and is steered by one vector.

Lossy compression occurs in the quantization and coding of the DCT coefficients. A higher compression rate can be achieved by quantizing more heavily, and vice versa. The ultimate success of the decoder in recovering a spatially compressed image (i.e., the extent to which the decompressed decoded version is indistinguishable from the original input) depends on its ability to decode the DCT coefficients and to apply the inverse of the DCT transform.

Macroblock errors occur when there are errors in an MPEG-2 video data stream such that the MPEG-2 video decoder cannot decode all the compression coefficients correctly. Such an error affects the entire macroblock of 256 pixels in the 16×16 array. The full picture is much larger than the macroblock. A macroblock affected by an error is a relatively small square in the picture.

If no error occurs, adjacent macroblock images normally merge together smoothly across their abutting borders because adjacent pixel values typically are nearly equal (although this situation is variable depending on picture content). Therefore, if no errors have occurred, the fact that encoding and decoding was done in macroblock units is not apparent from the resulting image data. With respect to the macroblock arrayed pixels, the decoded image is a seamless replica of the initial image, insofar as possible.

When an error occurs, which as stated affects all the pixels in a macroblock, the seamlessness of the decoded image is interrupted in a way that subdivides the resulting image data along the same lines or units in which the pixel data was processed, namely 16×16 macroblocks in the case of MPEG-2. An error-affected macroblock no longer merges seamlessly with the adjacent macroblocks and is rendered apparent in the output, typically by a perimeter of contrast between the error affected block and at least one (typically all four) of the surrounding adjacent blocks.

At times, macroblock errors are not isolated and two error affected blocks may abut. For example if the signal fades such that a succession of errors occur, a number of blocks in the picture are affected. Although two error-affected blocks may abut, it is most unlikely that the abutting error affected blocks will be affected in precisely a manner that produces a seamlessly smooth lack of contrast in the progression of pixel values across the border at which the affected macroblocks abut.

It is possible to react to detection of an error in various ways. In an MPEG-2 decoder, one might treat the video program stream as lost, if an error arose anywhere in a sequence of intra-coded (I), predictive (P) and bidirectional (B) pictures. The occurrence of an error in that event might trigger suspension of the moving picture program (e.g., showing a blank screen) until the opportunity to resynchronize arose with the next intra-coded (I) picture to arrive.

Dropping the display until an error-free restart is possible, might be more extreme than necessary, particularly if an error is momentary and localized to a particular block. Instead, one might allow the decoder to continue to decode even though an error has occurred that may have damaged the accuracy of one or more macroblocks of 16×16 pixels. This error could potentially continue to affect the picture until the next intra-coded (I) picture. If the error occurred in one macroblock or only a few macroblocks, and the video decoder can continue to synchronize with and decode the incoming video data stream, then it may be advantageous to continue to decode. Portions of the picture outside of the affected macroblock(s) could be perfect and error free, the picture failing only in those regions defined by the affected macroblocks.

In order to control how to handle an error condition appropriately, it is necessary to sense the occurrence of an error. It would also be advantageous if possible, to assess the gravity of the error.

Continued decoding of an MPEG-2 video stream, notwithstanding one or more macroblock errors, is perceived by the viewer as visible error blocks in one or more regions of the picture, of equal size (16×16) and persisting at a fixed location until the next intra-coded (I) picture is decoded without error. In the situation where the signal feed fades or has burst errors, the blocks come and go, occupying more or less of the picture area until the problem passes.

Analysis of macroblock data for errors is known in the sense of searching for illegal values or other numeric analysis, searching for misplaced marker bits, data reception errors, parity and CRC errors and the like. Several commercial products perform elementary stream analysis. The video elementary stream is extracted from the MPEG-2 signal and analyzed with respect to the compression coefficients. This is one technique for detecting the occurrence of a macroblock error, but requires test equipment that analyzes the MPEG encoding. MPEG test devices are also know that attempt to decode the elementary stream and signal an error if unable to successfully decode. That generally involves an extra MPEG decoder coupled to the signal at some point.

A different sort of known MPEG test apparatus compares a video stream decoded from a compressed data set, against the original input source program material, and signals an error when the decoded data and the original do not correspond. Signal quality analysis is possible by applying tests and comparing the results for the original source material versus the video waveform or other representation from the compressed version. Although effective, this technique requires that the source signal be made available for comparison. However, one of the primary objects of having a compression technique is to avoid the need to retain and transmit the full and uncompressed source.

### SUMMARY OF THE INVENTION

According to one aspect of the invention, errors introduced when encoding, transmitting, processing and/or decoding data that has been handled in blocks of samples, such MPEG-2 video data streams or other compressed data, are detected by discriminating for telltale effects that the errors produce in the output after decoding. In particular, the invention senses for contrasting data values at block positions and/or block sizes corresponding to the blocks used for compression. This technique makes it possible to distinguish blocks affected by errors from other blocks that might or might not also be affected by errors, in a simple and effective way, without the need to compare the decoded output data to the original pre-compression input data.

The invention is applicable to video data compression techniques, and particularly to standardized video compression such as MPEG-2, wherein pixel samples are handled in defined macroblocks for certain purposes. The invention responds to the contrasting appearance in the output image of one or more blocks that were affected by errors, versus the appearance of blocks that are unaffected by errors, by using image analysis filtering and processing techniques to respond strongly to the appearance of a pattern in the output that corresponds to the size, shape and/or relative position of a macroblock. This appearance is determined by sensing for data value contrast.

If certain blocks were encoded, processed, decoded, etc. without errors, those blocks merge into one another seamlessly, without introducing a distinct line of contrast. However, an error affecting one or more samples in a block generally affects the entire block, and introduces contrast between that block and adjacent blocks. Detectable contrast occurs between adjacent blocks whether or not errors occurred in only one block or in two or more. Contrast also occurs due to variations in program content, but image processing techniques are employed to respond strongly to contrast at macroblock edges in several ways. Edge contrast enhancement is used to highlight contrasting edges, e.g., to increase the extent of contrast. By use of one or more spatial image processing transforms, this effect is enhanced further with respect to lines aligned to block borders, typically horizontal and vertical lines. Threshold adjustments can be used to raise or lower the threshold of detection, to account for image content situations that inherently have greater or lesser contrast.

Macroblocks are standardized in size and shape, and generally occupy discrete positions in the array of pixels and corresponding macroblocks that make up the picture. Therefore, the preferred image processing techniques according to the invention can be very specific as to the nature, location and character of values that are identified as an error-affected macroblock. As discussed, a standard block may be a 16×16 pixel array. In a preferred inventive arrangement, the discrimination for macroblock edges is raised by calibration steps that first determine the expected position of the edges of at least one detected macroblock, and infer the edges of a substantially larger grid of abutting macroblocks. By digital signal processing techniques, the search for macroblocks is improved by threshold adjustments that are position specific. In one embodiment, the detector is arranged to respond strongly to contrast that aligns precisely with the lines of the inferred grid.

For edge enhancement, convolution mask filters can be applied to increase the contrast of adjacent pixels found in a display to define edges. For example, a Sobel filter convolution mask can be used to enhance lines of contrast using a set of 3×3 pixel convolution matrices. This technique increases contrast of a sort associated with block edges, while generally decreasing other contrast, such as contrast between pixel values at remote pixel positions.

The data filtering operations can include line thinning and other related image processing techniques. In a preferred arrangement, a Hough transform and a Hough plane analysis are applied. These and other techniques complete the processing by treating the figures in a contrasting image in a transform space or by virtue of criteria related to the extent of correspondence between found figures or shapes versus attributes of macroblock edge lines (e.g., relative sensed vertical and horizontal alignment, length equal to one or an integer multiple of macroblock sides, etc.). These and other such image analysis techniques can be applied according to the invention to detecting the distinct appearance of blocks affected by errors.

According to an inventive aspect, errors are detected in this way from analysis of the appearance of the output picture for certain attributes. The invention can be embodied as a separate apparatus for producing a data or switching signal to invoke an alarm or a corrective switching or gain control action or the like. Alternatively, the invention can be a built in aspect of a video processing system.

It is an object of the invention to detect compression/decompression errors in a block processing data stream by discriminating for distinct aspects of error-affected blocks in the output of a decoder thereof.

It is another object to detect MPEG-2 video data macroblock compression/decompression errors in this way, and to do so wholly from aspects of the picture output without the necessity of special decoders, analyzers or references back to the original source signal. This advantageously, but not necessarily, involves a digital data analysis of pixel values in a pipeline data processing arrangement in which frames or fields of data are stored in a digital array and shifted through the necessary computational elements as described.

Another object of the invention is to optimize error detection by discriminating for contrast around the perimeters of macroblocks, including by sensing for macroblock perimeters at specific positions in a picture signal coinciding with the perimeters of decoded blocks. According to one aspect of the invention, this optimization can include calibration. The relative position of at least one macroblock perimeter is determined as defined by contrast. This can be by searching throughout a signal, or more preferably by determining and/or better refining the position of a macroblock in a region that generally coincides with the expected position of a decoded block.

Assuming the block positions are not known precisely at the outset, once a block is detected, the position of other blocks is known to be related by pixel count to the block edge that have been located (in integer multiples of 16 pixels in the case of MPEG-2). Likewise, it is known that the grid lines in that case are vertical and horizontal. Precisely, or subject to windowing to forgive quantization and slight alignment errors, the later discrimination steps for other macroblocks in the same frame or field, or in later frames or fields, can be enhance for detection of macroblocks in specific positions. This calibration and/or windowing technique makes the error detection strongly responsive to macroblock errors and helps to preclude erroneous error detection responses due to program content.

It is an object to detect errors in an MPEG video stream relying substantially or even exclusively on aspects of the decoded video. Another object is to accomplish error detection in a manner that is readily applicable to NTSC, PAL, and other standard picture formats, as well as still images, animations of images and computer graphics, in either analog or digital form. According to the invention, this involves sensing the contrast associated with error-affected data compression blocks in the decoded output of the compression/decompression system.

These and other objects are accomplished to detect errors in a decoded video signal that has been processed at least partly in data blocks, such as MPEG-2 compression macroblocks or other block processed data, by discerning the appearance of a pattern of contrast in the decoded output video signal around the perimeter of an area corresponding to a processed block of pixels. In a compression technique, an error affecting one more members of a block of pixels generally affects the entire block. In the absence of an error, processed blocks most typically merge into one another with little if any contrast, i.e., with pixel luma and/or chroma values may that typically change little, if at all, across the border between abutting blocks. A block error alters this situation and produces detectable contrast between the affected block and at least one abutting block. Image processing techniques are employed to discern an apparent block as a function of contrast and thereby to discriminate for errors. The errors can be handled as appropriate, such as by generating an alarm, triggering a substitution of signal sources, repeating a stored block or the like.

In a preferred embodiment, the discrimination for contrast comprises steps including edge enhancement and thinning steps, Hough transformation and analysis, and one or more threshold discriminations involving aspects such as amplitude, difference (contrast), line orientation relative to expected block edges, line length (especially in integer multiples of block edge length) and similar aspects that are consistent with a block.

In another preferred embodiment, the threshold discriminations are subject to a variable threshold. By preliminary assessment of the content of an image, it is possible to increase a threshold if a large number of contrast features are found to be present, and to decrease the threshold if there is little contrast present, thereby increasing the sensitivity of the error detection method over a range of possible image content situations.

In yet another embodiment, the analysis of the block processed data for evidence of block edges is performed with substantially higher discrimination applied to portions of the image where block edges are expected to occur. In certain image processes, the block edges are known to occur at a certain pixel position in the image, and a very sensitive (low) threshold of detection can be applied to sense contrast at or very near the expected block edges, in a form of spatial windowing. Alternatively and in particular where the relative registration of the grid of abutting data blocks is not known or is known only to a particular window of tolerance, the process is preferably self calibrating. Using a given threshold with either a wide search window or no search window (namely when searching across the whole frame), a search is conducted to located and precisely determine the placement of a macroblock. All other macroblocks in the frame should be referenced or registered to on another because the blocks are of predetermined pixel size (16×16 for MPEG-2) and the blocks abut. Thus after registering to one found macroblock (preferably more than one, if present), highly discriminating contrast detection steps can be used specifically on the grid lines corresponding to all the other macroblocks that are referenced in position relative to the found block.

A memory or data store holds values representing at least portions of the decoded signal representing adjacent blocks of pixels in an area of one of space and time. The portions are at least slightly greater than individual blocks, such that the stored portion contains at least a slight area around the perimeter of a block to be tested as a block that is potentially affected by an error. In a preferred arrangement, a full image frame is stored and the image processing and analysis steps are performed using a digital signal processor chip coupled to the data store. The process can be repeated on a frame-by-frame basis.

A data analyzer discriminates for at least one contrasting aspect defining at least one perimeter of one of the blocks, and controls an output coupled to the data analyzer for indicating discrimination of at least one of said blocks as determined by detection of said contrasting aspect at said perimeter. The data analyzer can discern contrast between pixel values within a block from those outside, particularly over the perimeter edges between abutting blocks. In a preferred arrangement, image processing techniques process the image of a full video frame or field, to provide a processed version in which the contrast of certain aspects of the image are first enhanced, such as Sobel filters involving application of a convolution matrix to enhance lines of contrast or image edges. The processed signal can be handled in Hough space, or image space, for discerning whether or not any detected vertical and horizontal lines occupy positions that are consistent with a processed block. The discernment can be for the size of a processed block in a compression system such as MPEG-2 wherein a processed macroblock is known to have a given pixel array size of 16×16 pixels. In a compression system where blocks are known to occupy a given area of the image, the placement as well as the size of the discerned blocks can be used to discriminate error-affected blocks. The invention can be applied for each instantaneous frame or field, whether or not interlaced, and can require persistence of a detected error over a given number of pictures, for example between successive intra-coded pictures of an MPEG-2 decompressed video signal.

### BRIEF DESCRIPTION OF THE DRAWINGS

There are shown in the drawings certain embodiments of the invention as presently preferred. Throughout the drawings, the same reference numbers have been used where possible to identify the same elements. It should be understood that the invention is not limited to the precise arrangements and instrumentalities shown in the drawings, which intended to be exemplary rather than limiting. In the drawings,

FIG. 1 is a schematic diagram showing the error detection apparatus of the invention as applied to an MPEG-2 video compression situation.

FIG. 2 is a flowchart showing an exemplary technique for analyzing a captured image frame according to the invention.

FIG. 3 is a schematic illustration showing application of an image processing technique to discriminate for block shapes formed in contrasting portions of a captured frame.

FIG. 4 is a plot showing a processing region applied to a block error.

FIG. 5 is a flowchart illustrating a calibration procedure according to one embodiment of the invention.

FIG. 6 is a two representation showing an input signal that is encoded in blocks, decoded subject to occurrence of an error, and examined for contrast to detect a the error as a function of resulting contrast inserted into the output by the error.

### DETAILED DESCRIPTION

The invention is described with particular reference MPEG-2 compressed video signals. It should be appreciated that the invention is also fully applicable to other formats and other types of signals, not limited to MPEG or to video or even to compression as opposed to other techniques wherein a processed version of a signal is produced and a replica is produced that is intended to correspond to the original input in one or more aspects. The invention is also capable of embodiment as a digital system or an analog one, and can be provided as a distinct article of test equipment or can be incorporated into a system with other capabilities. In any event, terms that have a specific connotation respecting MPEG-2 (e.g., “macroblock”) and specific block sizes (e.g., 16×16 pixel compression blocks with luma/chroma sampling ratios 4:2:0), as well as other terms or specific conditions that are consistent with MPEG-2, are intended to be exemplary only, and not to limit the invention solely to the MPEG-2 format.

According to a preferred arrangement, the detection of macroblock errors is done using image processing techniques to detect patterns in the output that are characteristic of errors. The detection analysis is applied to a version of the video or other block-processed data after it has been decoded. It is not necessary to have access to the original input data prior to compression. Nor is it strictly necessary to have any knowledge of the algorithm by which the data was block processed, e.g. compressed by a macroblock technique. All that is needed is the output data and knowledge of how errors affect the output.

In connection with MPEG-2, it is known that compression is effected using 16×16 pixel macroblocks. If the compression and decompression works perfectly, each 16×16 macroblock in the output merges seamlessly into the adjacent macroblocks. When an error occurs, the entire 16×16 pixel macroblock is affected and the result is a line of contrast between the affected macroblock and the adjacent macroblocks. This characteristic of an error in the output is detected using image processing techniques that are sensitive to the size and shape of the macroblock and are responsive to a contrast or linear border in which there is a distinct change in one or more video attributes.

The output data analysis technique of the invention can be used search for any line of contrast throughout the decoded output (e.g., decompressed video). However the technique works most effectively if the search and analysis discriminate specifically for lines of contrast that occur at expected borders of macroblocks that occupy a known position in the pixel array of the output, and are of a known size.

In a preferred arrangement, a succession of image processing operations are used first to enhance the attributes of macroblocks and/or edges of macroblocks, and then to discriminate heavily for the combination of attributes that are expected in the event of a macroblock error.

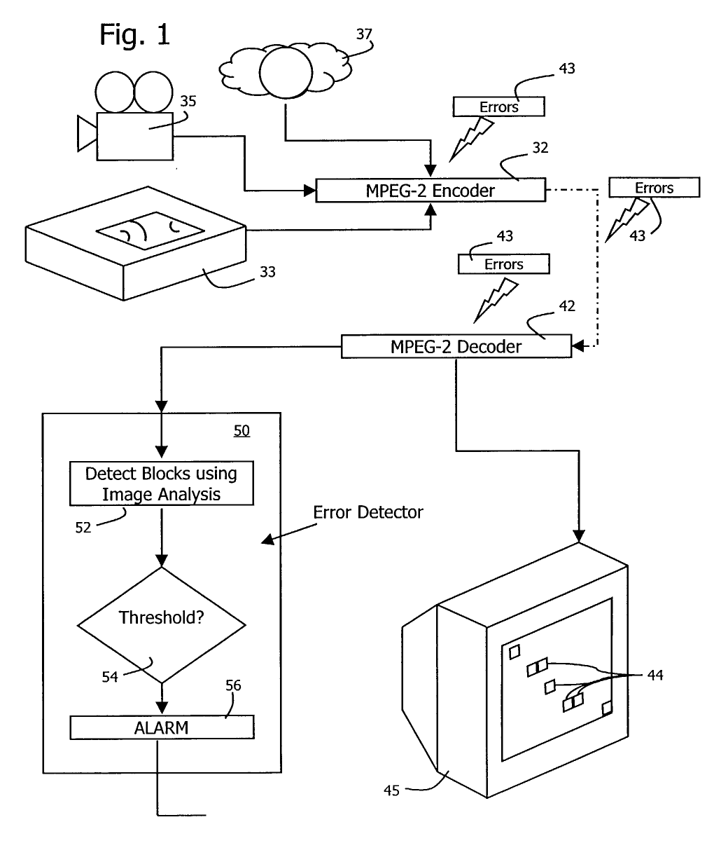

Referring to FIG. 1, an input signal to an encoder such as MPEG-2 encoder 32 can come from any source, such as a transmission from a recording/playback device 33, a video data collection device (camera) 35, a broadcast or network 37 or another signal source. The data source can also be a means for wholly generating a video signal (not shown). The source signal is applied to an encoder 32 that processes the signal in blocks, and in that processed form the signal is carried along an unspecified signal path shown in dash-dot lines in FIG. 1, to a decoder 42 that reverses the process, i.e., recovers insofar as possible the same signal that was applied as an input to encoder 32.

However, errors 43 of various types can affect the process of encoding, the passage of the signal, the decoding of the signal, etc. The errors could be due to the amplitude of the signal dropping off, to burst errors from induced electromagnetic noise, or other problems. The encoder 32 and decoder 42 respectively encode and decode the signal in discrete blocks. Thus any error 43 generally affects the block that was being encoded, transmitted, decoded, etc., when the error occurred.

According to an inventive aspect, an error detector 50 uses an image analysis technique, shown as block 52 in FIG. 1, to discriminate for blocks that are distinct from other blocks, and thus are a typical and presumably affected by an error. If no error has occurred, the output of the decoder 42 will generally consist of picture areas that merge smoothly into one another. When an error occurs, however, the affected block 44 becomes distinct from adjacent areas and/or blocks, as displayed on a television receiver 45 in FIG. 1. The error detector 50 uses image processing techniques to discern for distinct error affected blocks 44, such as using a threshold detection process 54 or the like applied to the pixel data values. Therefore, it is not strictly necessary to display the error affected blocks 44 as shown in FIG. 1. Various actions are possible when an error is detected (e.g., by sensing criteria exceeding a threshold or otherwise). An example is to operate an alarm 56 as in FIG. 1. An alternative might be to switch at least momentarily to an alternative signal source. Another example might comprise substituting values for the pixels in the error affected block, e.g., repeating display of the values during the previous picture frame and/or field, extending the values of the adjacent blocks into the affected block, or the like. Still another possibility could be simply to mark the signal to indicate the presence of the apparent error. These alternative actions are represented by the output of the alarm block 56, which output can be used for such signaling or switching uses as appropriate.

The preferred but nonlimiting example shown in FIG. 1 is an MPEG-2 compression encoding and decoding process. The source data is compressed video data that typically is digitized, and according to the MPEG-2 and other such standards, is encoded block-by-block using algorithms that encode pixel values and block steering vectors for each block using a discrete cosine transform or the like. The blocks have distinct attributes according to the compression standard, most notably being 16×16 pixels in size. Thus, when an error occurs, a 16×16 pixel block effect renders distinct the appearance of the error affected block or blocks. The invention uses image processing techniques to find in the output signal one or more blocks that meet predetermined criteria of a block. These blocks are found when an error occurs affecting the associated block.

The compression process effected by the encoder is reversed by a decoder and the output can be displayed on a receiver or otherwise employed. Between the encoder and the decoder, along the portion of the signal path shown in dash-dot lines, the signal might be stored or transmitted, while in compressed or processed form.

The invention is applicable to various processes, not limited to MPEG-2 and not limited to video processing, but wherein an encoding process associates portions of the input signal in blocks. Thus the errors tend to affect the whole block in which they occur. So long as encoding of the signal is error-free, and no errors are introduced during transmission or storage, decoding reverses the process by which the portions of the input were associated into blocks. That is, in the absence of errors, the reproduced replica of the input signal is substantially the same as the input, and those subdivided portions that may have been associated in blocks proceed smoothly and seamlessly from one portion to the next after decoding. The error detector of the invention exploits the fact that when errors occur, the portions of error-affected decoded blocks are prevented from being returned to the original seamless procession of the same portions in the original input. Thus the error-affected blocks have aspects whereby they are detectable in the decoded output.

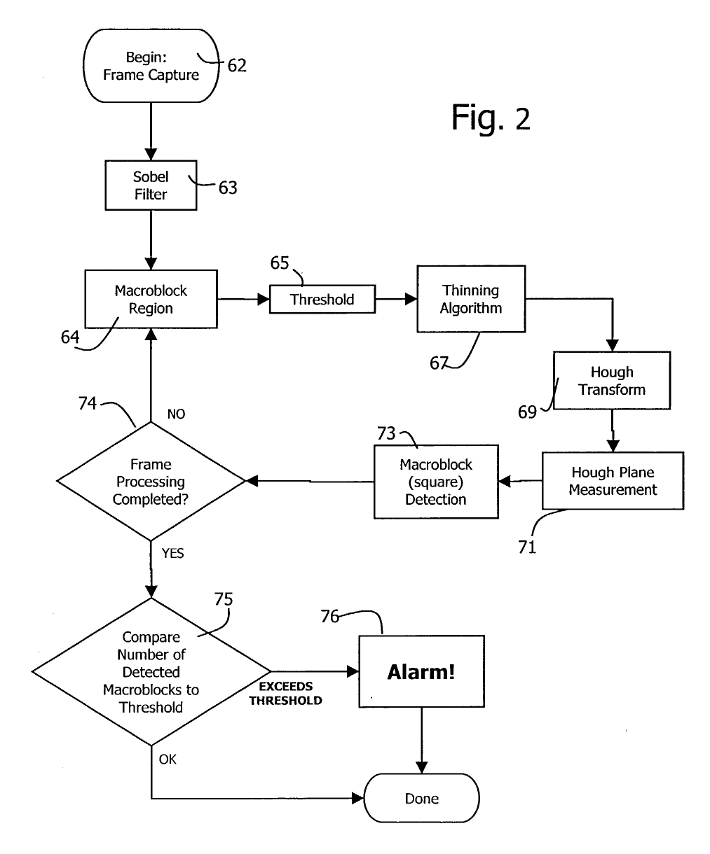

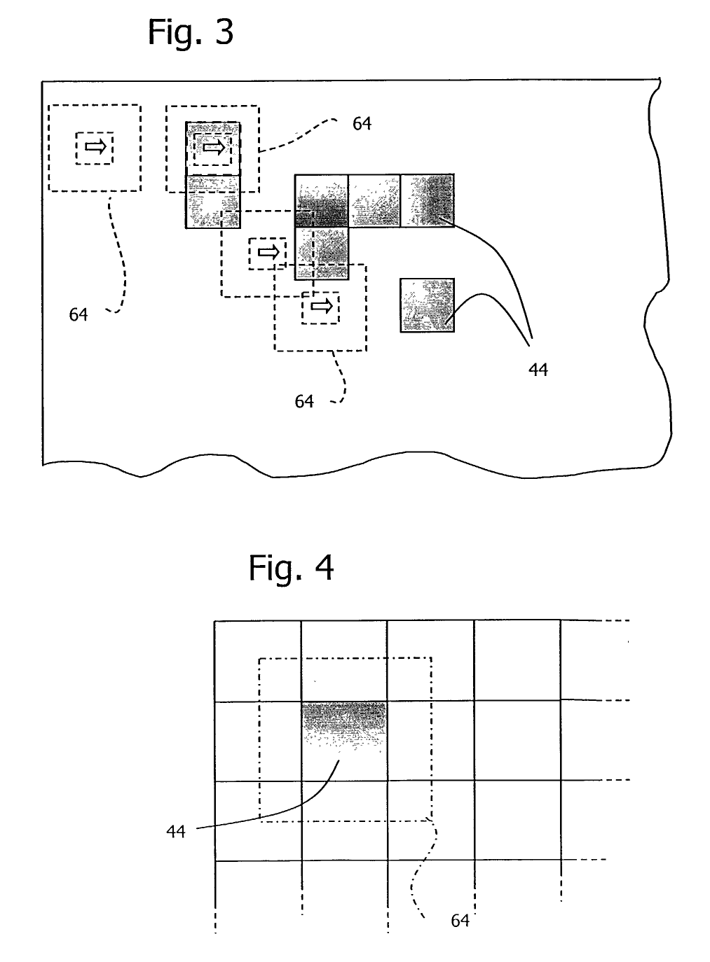

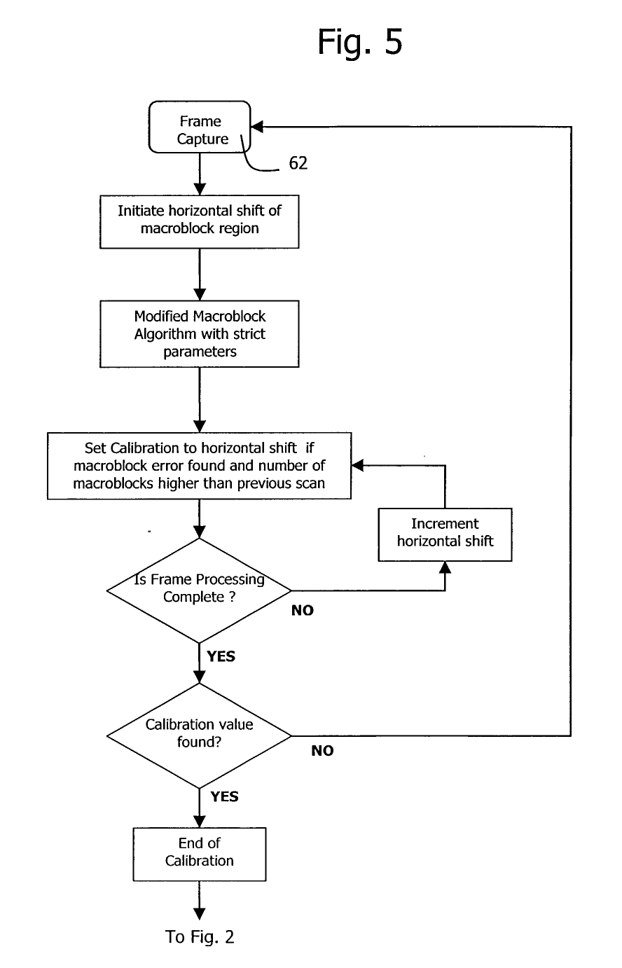

The detection of error-affected blocks in the decoded output is advantageously accomplished using a process such as that shown in FIG. 2. The signal is processed to enhance and highlight aspects that are consistent with error-affected blocks. Threshold detection steps can be included at various steps to discriminate or to conclude that a block is present. A threshold could apply, for example, as to whether a level of contrast is sufficient to potentially be deemed to contribute to a block perimeter line. A threshold can be applied as to the length or continuity of a line. Due to noise and quantization errors, the alignment of a line or the continuity of a line or figure (e.g., square) may not exactly meet all the aspects of an ideal error affected block. However, using threshold techniques, error affected blocks can be found to be present to a relatively good degree of certainty. Threshold detections also can be used in the generation of error alarms, such as the number of error-detected blocks, etc.

Referring also to FIG. 3, apart from one or more given error-affected blocks 44, the data or image might be error free or could have additional error-affected blocks, including blocks immediately adjacent to the affected block under consideration. Nevertheless, it has been found that the error-affected blocks have a distinct and detectable block shape that can be found as a function of contrast bridging over the perimeter of the blocks. That is, data values of pixels within the perimeter of the affected block contrast detectably with the data values of pixels outside of the perimeter of the block. Image processing techniques as discussed herein numerically enhance contrast of the type characteristic of blocks. In an embodiment wherein the block processed pixels form a rectilinear square or similar shape in the output, the technique preferably is most sensitive to combinations of lines of contrast the complement the block shape, i.e., vertical and horizontal lines of contrast that are spaced by the expected span of the block.

Initially, all edges are enhanced by contrast enhancing techniques such as application of a set of Sobel filter convolution masks. This tends to convert transitions in original image data into outlines in a processed contrast-enhanced version. Thinning steps can be employed to make the processed version into a collection of lines. The results are then examined, for example using a Hough transform and procedures transform space, for patterns of vertical and horizontal lines. In this manner, the intersections of vertical and horizontal lines at the apices of macroblocks and/or the occurrence of line segments at the sides of macroblocks, namely integer multiples of sixteen pixels in the example of MPEG-2, the invention discriminates for errors by finding the effects of such errors in the output signal.

By detecting the symptoms of macroblock errors, the invention provides an effective error detector without the need to obtain or to compare the original source signal to the decoded output. It is not necessary to know or to vary operations based on the specific way in which the compression encoding and decoding elements operate. All that is needed is the output signal. It is possible that the device of the invention could produce a false alarm when the encoding and decoding elements were working properly. Specifically, it is possible to process or transmit a correctly encoded and decoded signal wherein the correct content comprises one or more 16×16 pixel blocks that correspond to compression macroblocks in size and/or position, producing an alarm. However, this situation is only rarely encountered, for example when it is desirable to simulate error conditions in a signal.

Referring to FIG. 3, the invention can effectively search selected areas for contrast, such as the space between inner and outer zone lines that encompass the perimeter of error-affected blocks 44. As shown in FIGS. 3 and 4, zone lines can define a potential affected block region 64 to be analyzed. By applying the discrimination steps to a specific region, the discrimination for contrast can be localized and rendered free of the influence of other areas of an image. FIG. 5, discussed in detail below, illustrates another technique for reducing the sensitivity of the device to image content and thus increasing the relative sensitivity to contrast consistent with macroblock errors.

FIG. 2 illustrates a preferred but nonlimiting image processing method to be accomplished on the decoded signal to determine whether the characteristics of macroblock errors occur in the output. At the beginning block 62, a frame is captured, namely a data image of pixel values in luma and/or chroma. According to a preferred embodiment of the invention, the entire frame is captured and analyzed for certain contrast attributes. The captured data values that are preferably stored in a data memory (not shown) represent an area of the image that is at least as large as or at least overlaps the edge of a potential affected block. Preferably, the stored data includes a local block region that exceeds the size of a block on all sides.

The stored data values (which may represent the aforesaid region that overlaps edges of a block) preferably is passed initially through an edge enhancement filter such as a Sobel filter process 63, to highlight edges that occur in the signal by enhancing the detected contrast of such edges. This also tends to de-emphasize all other features apart from edges defined by contrast. The filter can be a convolution mask or matrix of factors or a set of such factors comprising two or more matrix patterns, sequentially applied to (i.e., matrix multiplied by) the arrayed values of every targeted pixel in turn. A matrix defined by a given targeted pixel and adjacent pixels that form an array around the targeted pixel, e.g., a 3×3 array of image data values, are matrix multiplied by the convolution matrix and the resultant is stored in a processed image array as the processed value for the targeted pixel position. The convolution mask can be multiplied by the pixel values for chroma and/or luma, or a processed combination of these values.

Sobel filters matrices are known for enhancing contrast and to assist in enhancing or rendering mathematically more apparent the presence of contrasting edges. Moreover, the Sobel matrix is oriented so as to preferentially enhance the contrast of edges that are oriented in a way that the matrix factors complement. According to the invention, the Sobel filter can preferentially enhance horizontal and vertical lines of contrast that appear in an image. For separately highlighting horizontal and vertical lines, a Sobel filter employs a matrix of factors to each pixel and its neighboring pixels in an array of samples. Exemplary 3×3 matrices for this purpose, sometimes known as convolution masks, could be:

$$( \begin{matrix}- 1 & - 2 & - 1 \\ 0 & 0 & 0 \\ 1 & 2 & 1\end{matrix} ) and ( \begin{matrix}- 1 & 0 & 1 \\ - 2 & 0 & 2 \\ - 1 & 0 & 1\end{matrix} )$$

Image processing masks are possible for highlighting edges that are aligned in various directions, and the typical MPEG-2 macroblock is a square block with vertical and horizontal edges relative to the picture borders. Nevertheless, at this stage the Sobel filter is generally useful to enhance contrasting edges and not so much for any capacity to discriminate for edges having a specific alignment. Such discrimination is aptly handled by Hough transform processes, discussed below.

A preferred Thinning Algorithm used is the Holt Variation of the classic Zhang-Suen algorithm. The Holt Variation is relatively fast compared to the classic Zhang-Suen, and image distortion is minimal. The thinning algorithm processes contrast data from the Sobel filter processed image to more nearly produce linear forms and figures of which some (particularly edges of error affected blocks) tend to appear as discrete lines.

Hough Transforms are used to process the thinned find straight lines in the processed image. Such a encoded features and figures in the image in a manner that is apt for processing to identify and discriminate for aspects that are consistent with an error affected block while limiting sensitivity to other aspects, such as those produced by variations in intended image content. For example, a straight line in the image corresponds to a point in a Hough Parameter Plane. The more pixels aligned at a certain angle, the higher the accumulated value associated with these points will be. The position in the Hough Parameter Plane indicates the angle of the line and its distance to a center.

In the preferred process for detecting macroblocks, only two angles need to be analyzed, namely zero degrees and 90 degrees, representing the horizontal and vertical lines of the perimeter of a macroblock. By applying a threshold to the Hough Parameter Plane to discriminate at the zero and 90 degree alignments, it is possible to discriminate for horizontal and vertical lines in the image. Additionally, by measuring the distance between points in the Hough Plane, it is possible to determine the distances between horizontal and vertical lines in the image. By an appropriate collection of steps to find lines, to discriminate for orientations, and to selectively respond to aspects including distances between lines or intersections or the like, the appearance of one or more macroblocks is detected in the image.

The Hough Transform was the method chosen because it responds well to aspects consistent with macroblock features while filtering out spurious noise, slight misalignment and discontinuities of the macroblock edges and other confounding factors.

A macroblock in MPEG-2 is a block of 16×16 pixels, with vertical and horizontal edges. An error-affected block in the decoded signal forms a discontinuity in the video image, framed by contrasting data values inside and outside of the macroblock. The Sobel filter increases the contrast of such a pattern in a processed version of the image data. The extent of contrast varies with the content of the image and the nature of the error.

Referring also to FIG. 3, by applying a Sobel filter and Hough transform, the effect is to focus on the distinction of vertical and horizontal lines. This effectively enhances the distinctions consistent with a macroblock and decrease other distinctions such as features other than lines of contrast, or lines of contrast oriented along lines other than vertical and horizontal or at positions that do not as a whole correspond to the attributes of macroblocks.

At block 64 in the flowchart of FIG. 2, a macroblock region 64 as shown in FIG. 3 is selected for processing to determine the presence of an error affected block 44 therein. This could be accomplished by discriminating for lines of contrast forming a square of a size corresponding to a macroblock or other similar processed unit.

Depending on image content, there could be various contrasting regions in the image. Selecting a macroblock region 64 reduces the area of consideration more nearly to the expected size and shape of an error-affected block. A threshold step 65 in FIG. 2 is applied to eliminate contrast that is less than a predetermined absolute value difference, and preferably to reduce the extent of level variations. For example, the threshold step can convert a Sobel filtered processed output image to a ones/zeroes (black/white) bitmap wherein contrasting levels are reduced to binary values. Next a thinning algorithm 67 is applied to reduce the thickness of lines of contrast while retaining the continuity of adjacent points that form a line.

There are a plurality of potential applications of threshold detection as described, not limited to distinguishing between binary levels of contrast versus lack of contrast when distinguishing edges. In connection with the thinning steps 67, for example, a threshold distinction can apply as to whether to reduce the thickness of a line. After the Hough measurements 71 or measurements of the results of Hough transform 69, the detection step 73 can involve comparing measured values to thresholds. Thresholds can be applied in the Hough plane, to the distance between lines, and to the position of the lines.

After processing is completed on a macroblock region 64, the process is repeated on a next region until the frame processing is completed (step 74). Another threshold comparison 75 can be used to determine whether or not to generate an alarm. (Although the threshold in that case might be met upon detection of just one macroblock as opposed to some higher threshold number.)

In a preferred arrangement, at least one of the threshold is preferably variable to comport with the content of the image. In this manner, the device can be more or less discriminating. It is possible to be more discriminating, without false error detection, if the content of the image generally has low contrast. The threshold can be low and sensitive. If the content has substantial contrast, it is possible to use a high threshold, for example at step 65, to reduce the sensitivity to contrast. In that case, the sensitivity to line features at step 73 can have a relatively tighter and more sensitive threshold level by comparison. These thresholds and optionally additional ones can be adaptive, being raised or lowered to normalize the error checking parameters such that error detection is only as sensitive as the content of the image will allow

The foregoing steps represent image processing arrangements that can be appreciated by reference to FIGS. 3 and 4. The Sobel filter produces an edge detection that substantially converts the illustrated gray error-affect blocks into square outlines. For macroblocks, the outlines fall into a particular area, namely the perimeter or thick square band zone of regions 64. By discriminating for the appearance in the decoded data for lines of contrast of the required orientation, namely vertical and horizontal, and the required position, namely intersecting at the corners of a square and preferably also occurring at particular locations known to be potential macroblocks, it is possible dependably to detect macroblock errors that occur.

A self-calibration procedure is possible, for example as shown in FIG. 5 and is advantageous in an embodiment wherein the location of unregistered macroblocks on the image can be predicted or inferred, or determined by reference to other blocks. The macroblock detection method of the invention works by looking for blocks outlined by contrast with adjacent blocks as described above. As shown in FIG. 3, the blocks can be searched at particular vertical and horizontal positions, particularly in systems wherein block errors are known to occur at fixed locations or approximate locations on the image frame or screen.

The location of macroblocks on an NTSC or PAL system when it is encoded into MPEG-2 compressed stream is fixed. The horizontal resolution of a MPEG-2 compressed NTSC video is 720 pixels, and the vertical resolution is 480 lines. PAL horizontal resolution is the same, and vertical resolution is 576 lines. Each macroblock has a fixed size of 16×16 pixels, which means that 45 macroblocks are needed to fill 720 pixels horizontally (720/16=45). In such an arrangement, it may be inferred that unless the image data is preprocessed or cropped, etc., macroblock edges will occur at a specific line height and a specific integer multiple of 16 pixels from an edge. There may be digitization errors of a pixel or so in either direction, but a search for contrast can be effectively localized by knowing where to concentrate the search to detect contrast lines.

When an MPEG-2 compressed digital stream is converted to analog video and the decoded output is examined as described herein, there could be a horizontal shift of the whole frame to the left or right, in addition to the foregoing digitization error. The shift is carried along by the mapping accomplished when that the MPEG-2 decoder converts between MPEG-2 digital video to analog video. Another example of a horizontal shift is if the output of the MPEG-2 decoder passes through other post-processing equipment such as distribution amplifiers, video switchers, frame synchronizers, processors and amplifiers. These types of equipment could slightly shift the analog video to the left or right, in a way that may or may not accumulate but generally renders the precise position of macroblocks less certain.

The macroblock detection nevertheless can advantageously be made highly sensitive to the location of the blocks in the analog video. A calibration procedure, for example as shown in FIG. 5, can be used to locate the horizontal position of the macroblock on the video frame.

The calibration procedure is used to locate the exact location of the MPEG-2 macroblocks in the analog video frame. There is challenge in the error detection process to distinguish content-based contrast from macroblock errors. This challenge can be readily met if the block locations are known, or are nearly known, such that image discrimination techniques can be concentrated precisely to determine whether or not a line of contrast occurs at a specific location. The detection procedure can be more loose as to position, potentially searching macroblock errors by attempting to discriminate for lines of contrast in the required combinations anywhere in a macroblock region that is larger than the macroblock error itself. However the extra searching is a more complicated and/or takes longer than testing for contrast at known locations, and is optimally subject to a lower level of discrimination to prevent undue false triggering. According to an inventive aspect, this matter is resolved by providing a technique for the device to find one or more macroblocks according to a wider ranging search, and to employ the results to define a registered pattern where other blocks should appear relative to the one found. Thus the discrimination for error is calibrated to search for contrast at known locations by first learning what the locations should be.

A first macroblock error must have occurred and be found by the system of the invention. Although the general location of a macroblock may be known, it can be assumed for purposes of illustration that the macroblock locations are wholly unknown before calibration. A first step as shown in FIG. 5 is to apply the macroblock algorithm over the same frame multiple times, scanning the image for macroblock errors. At each iteration the number of macroblock errors is recorded and the macroblock regions are shifted by a pixel. After the multiple scans of each frame, the location that has the maximum number of macroblock errors is considered the horizontal calibration shift value. If there is no macroblock error detected in the frame, nothing is recorded and the calibration is repeated in the next captured frame.

In order to locate the optimal calibrated position for the macroblocks, the macroblock detection algorithm can be modified. The parameters (location and distance between block edges) that decide if there is a macroblock error in the macroblock region are preferably made more strict to refine the registered grid of macroblock locations. That way, only precise macroblock error squares are detected. This causes a more accurate calibration process and prevents false alarms and false calibration.

To make the calibration even safer, the whole calibration process is repeated and a calibration is considered successful only if the calibrated horizontal shift value is found to be the same over different frames. The process can also be repeated periodically or upon occurrence of some event.

FIG. 3 includes some shaded blocks representing macroblock errors, wherein the shading defines a gradient. It can be appreciated from such a shading situation that at times two adjacent blocks that have errors could potentially have relatively little contrast relative to one or more of the adjacent blocks. Nevertheless, it has been found that dependable error detection is possible, particularly when adaptive thresholds are applied to the various steps, including but not limited to the Sobel factors, the thinning algorithm (see also FIG. 2), the digitization threshold 65, the Hough transformed detection 73 position, or other image aspects are examined for predetermined features.

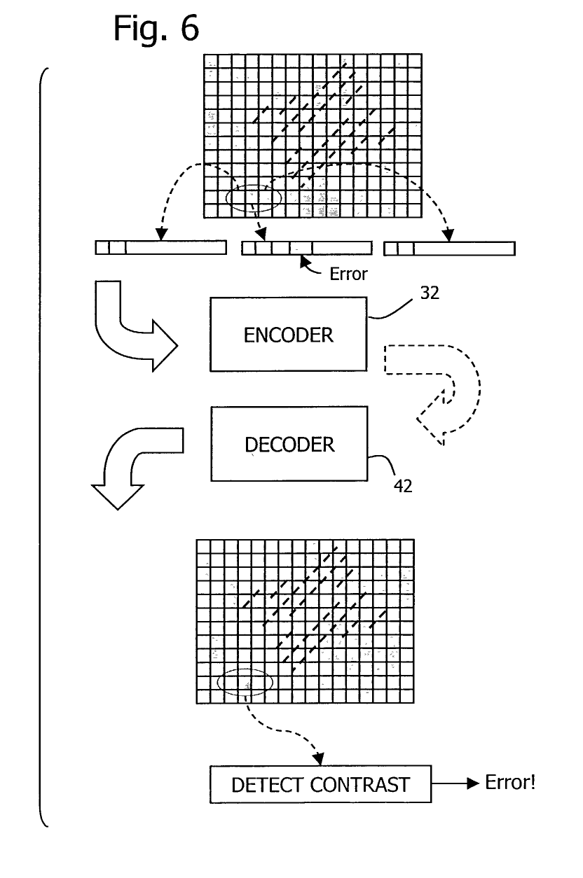

FIG. 6 illustrates the effect of the invention in a graphic snapshot. Upstream of the encoder 32 on the signal path, the input signal has any variable content but the portions that are to become blocks, which are separately encoded, are subject to errors, one being shown as an example. Downstream of decoder 42, the result is a contrast that was not present in the initial signal, and which is detectable as discussed to generate an error indication, switching step or similar result.

The square macroblock unit of MPEG-2 compression encoding is one example of an application of the invention. It is possible to apply the invention to other compression units with appropriate adjustments. For example, a compression block unit other than 16×16 pixels could be used. The blocks could be fixed in position on the image or variable in position. The block size could be variable or otherwise subject to detection (e.g., by distinct shape). It should be apparent that the invention could be applied to shapes other than squares, such as rectangles, triangles, hexagons, trapezoids, etc. The invention can also be applied to successions of pixel values that extend temporally through more than a single frame or field.

Contrasting edges that occur at and/or adjacent to the borders between the encoded/decoded blocks can be determined exclusively from contrasting luma values, which has the usual benefit of providing more samples than chroma. Nevertheless, a macroblock error can be detectable by contrast in the sense of a chroma change or a luma change or any combination of contrasting values in one or more of the any color space parameters.

When an error is detected, the invention produces a signal that can trigger an alarm, cause a marker to be inserted, can switch the source of the signal being processed or its destination, cause an alternative block to be inserted in lieu of the error affected block, etc.

The invention having been disclosed, a number of variations should now be apparent to persons skilled in the art. Reference should be made to the appended claims rather than the foregoing discussion of exemplary preferred arrangements, to assess the scope of the invention in which exclusive rights are claimed.

What is claimed is:

1. An error detection system for discriminating for errors in a video signal processed from data blocks whereby said errors affect discrete blocks of pixels in a picture defined by the video signal, comprising:
a data store operable to store at least portions of the video signal representing adjacent blocks of pixels in an area of one of space and time, said portions being at least slightly greater than the blocks;
a data analyzer operable to discriminate for at least one contrasting aspect defining at least one perimeter of one of the blocks; and,
an output coupled to the data analyzer for indicating discrimination of at least one of said blocks as determined by detection of said contrasting aspect at said perimeter.

2. The error detection system of claim 1, wherein the video signal processed from data blocks is a compressed signal in which the data blocks are local compression blocks.

3. The error detection system of claim 2, wherein the video signal is a form of compression employing macroblocks consisting of an array of spatially adjacent pixels in a picture.

4. The error detection system of claim 3, wherein the video signal is an MPEG-2 compression and the macroblocks are a square array of commonly encoded pixels.

5. The error detection system of claim 1, wherein the data analyzer applies at least one variable threshold adjustment.

6. The error detection system of claim 1, wherein the data analyzer applies at least one contrast related discrimination test that is concentrated at a defined location on an image frame associated with an edge of a compression block.

7. The error detection system of claim 6, wherein the defined location is movable during at least one said discrimination test for calibration of a position of a compression block.

8. The error detection system of claim 7, wherein the analyzer concentrates at least one discrimination test at a location determined with reference to said calibration of the position of the compression block.

9. A signal processing system, comprising:
an encoder operable to apply a first process to a generally continuous input signal so as to provide an output signal wherein the input signal is characterized as a succession of processed blocks, each of the processed blocks representing a portion of the input signal;
a decoder operable to decode the output signal by applying a second process to the processed blocks, for reversing said first process and recovering a replica of the input signal;
wherein an error affecting at least one of the encoder, the processed blocks and the decoder tends to render at least one affected block discontinuous relative to at least one adjacent block in said replica;
an error detector operable for sensing continuity and discontinuity between successive blocks of the replica, the error detector producing an output triggered by the error when said discontinuity exceeds a predetermined threshold.

10. The signal processing system of claim 9, wherein the input signal is a video signal and the blocks are data compression blocks.

11. The signal processing system of claim 10, wherein the error detector comprises an image analyzer responsive to contrast in shapes defined in said replica, the shapes having at least one of a predetermined size, shape, spatial position and time of occurrence in the video signal.

12. The signal processing system of claim 9, wherein the error detector is sensitive to said continuity and discontinuity on leading and trailing edge of the affected block.

13. The signal processing system of claim 9, wherein the input signal is a video signal and the error detector is sensitive to discontinuous change in at least one of luma and chroma in portions of the replica corresponding to the blocks.

14. The signal processing system of claim 11, wherein the error detector is sensitive to a position of the affected block, and wherein the position is changeable by relative position of the blocks over an image frame.

15. A method for detecting errors in a decoded version of a block encoded video signal, wherein error-affected blocks can appear in the decoded version, the method comprising the steps of:
analyzing at least a region of the decoded version for a contrasting aspect of the video information corresponding to at least one perimeter of an error-affected block;
signaling an error when said contrasting aspect is found at said at least one perimeter.

16. The method of claim 15, comprising decoding at least one frame of said video information and employing an image processing technique to analyze said region for said perimeter.

17. The method of claim 16, wherein said analyzing includes application of a convolution filter to the video information for emphasizing lines in the video information.

18. The method of claim 17, wherein said analyzing further comprises determining whether said lines include a line corresponding to predetermined positions of perimeters of the block.

19. The method of claim 17, wherein the video information is block encoded according to a standard and wherein said analyzing further comprises determining whether said lines include a line corresponding to predetermined positions of perimeters of the block.

20. The method of claim 15, wherein said analyzing comprises adjusting at least one of a threshold detection level and a position at which contrast is tested preferentially for detection of the block at a calibrated position referenced to at least one of a previously detected block and a characteristic of content of the video information.
